(19) United States
(12) Patent Application Publication
(10) Pub. No.: US 2014/0051795 A1
(43) Pub. Date: Feb. 20, 2014

(54) HIGH IMPACT LONG FIBER REINFORCED POLYAMIDE COMPOSITION

(71) Applicant: SABIC Innovative Plastics IP B.V., Bergen op Zoom (NL)

(72) Inventor: Kapil Inamdar, Chester Springs, PA (US)

(21) Appl. No.: 13/969,076

(22) Filed: Aug. 16, 2013

Related U.S. Application Data
(60) Provisional application No. 61/684,474, filed on Aug. 17, 2012.

(51) Int. Cl. C08L 77/06

(52) U.S. Cl. CPC C08L 77/06
USPC 524/538

(57) ABSTRACT

Disclosed herein are composition and methods. The compositions are fiber reinforced thermoplastic composition comprising an impact strength increasing additive and/or a mechanical property improving additive.

### CROSS-REFERENCE TO RELATED APPLICATIONS

This application claims the benefit of U.S. Provisional Application No. 61/684,474, filed on Aug. 17, 2012, which is incorporated herein by reference in its entirety.

### TECHNICAL FIELD

The present disclosure relates to fiber reinforced polyamide polymer compositions having superior properties and performance.

### TECHNICAL BACKGROUND

Certain fillers or additives can be used to boost performance characteristics of polymeric resins. In particular, an improvement in physical properties of the polymers can be achieved through addition of common reinforcements such as glass fibers, carbon fibers, mineral fillers, etc., among others. As such, long fiber reinforcements in thermoplastic resin can improve impact properties of the product. As a general rule of thumb, the higher the filler content the higher the properties can be within reasonable limits of the filler amount. Filler content levels beyond reasonable limits, i.e. too high filler content, does not improve the properties in the product further. Further, as one works with different types of fillers, the ease of processing and molding becomes an important factor due to the need to maintain practicality of operations.

It can be desirable to improve the impact properties of a given product even beyond the benefits achievable with long fiber reinforcements.

Accordingly, there remains a need for fiber reinforced thermoplastic compositions that can provide improved properties and having an ease of manufacture through a variety of methods. These needs and other needs are satisfied by the compositions and methods of the present disclosure.

### SUMMARY

In accordance with the purpose(s) of the invention, as embodied and broadly described herein, this disclosure, in one aspect, relates to fiber reinforced polymer compositions having superior properties.

As described more fully herein, in one aspect, disclosed herein is a fiber reinforced thermoplastic composition, comprising: a polyamide polymer component; a fiber reinforcement component; a lubricant component; and an impact strength increasing additive other than the lubricant component. In one aspect, the fiber reinforced thermoplastic composition comprises a) from 30 to 65 weight percent of the polyamide component; b) from greater than 0 to 70 weight percent of the fiber reinforcement component; c) from greater than 0 to 1 weight percent of the lubricant component; and d) from greater than 0 to 3 weight percent of the impact strength increasing additive.

In another aspect, disclosed herein is a fiber reinforced thermoplastic composition, comprising a) a polyamide polymer component; b) a fiber reinforcement component; c) an optional lubricant component; and d) a mechanical property improving additive other than the optional lubricant component. In one aspect, the fiber reinforced thermoplastic composition comprises a) from 30 to 65 weight percent of the polyamide component; b) from 35 to 70 weight percent of the fiber reinforcement component; c) from greater than 0 to 1 weight percent of the optional lubricant component; and d) from greater than 0 to 3 weight percent of the mechanical property improving additive.

Also disclosed herein is a method for increasing the impact strength exhibited by a conventional fiber reinforced polyamide formulation comprising a weight percentage of a fiber reinforcement component; a weight percentage of a polyamide component; and a weight percentage of processing aid component; the method comprising: a) providing the conventional fiber reinforced polyamide formulation; b) determining a weight percentage of an impact strength increasing additive, other than the processing aid component, to be incorporated into the conventional fiber reinforced polyamide formulation; c) substituting the determined weight percentage of the impact strength increasing additive for a corresponding weight percentage of the polyamide component to provide a fiber reinforced polyamide formulation exhibiting an increased impact strength; and d) preparing a fiber reinforced polyamide composition according to the provided fiber reinforced polyamide formulation of step c).

Also disclosed herein is a method for improving one or more mechanical property exhibited by a conventional fiber reinforced polyamide formulation comprising a weight percentage of a fiber reinforcement component; a weight percentage of a polyamide component; and a weight percentage of a processing aid component; the method comprising: a) providing the conventional fiber reinforced polyamide formulation; b) determining a weight percentage of a mechanical property improving additive, other than the processing aid component, to be incorporated into the conventional fiber reinforced polyamide formulation; c) substituting the determined weight percentage of the mechanical property improving additive for a corresponding weight percentage of the polyamide component to provide a fiber reinforced polyamide formulation exhibiting at least one improved mechanical property; and d) preparing a fiber reinforced polyamide composition according to the provided fiber reinforced polyamide formulation of step c).

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated in and constitute a part of this specification, illustrate several aspects and together with the description serve to explain the principles of the invention.

FIG. 1 shows the data in the form of spider charts of the respective long glass fiber (LGF) content levels. The benefit of Struktol® TR 063A in improving notched Izod impact (NII) for 60 wt % glass fiber content is observed in FIG. 1.

### DETAILED DESCRIPTION

The present invention can be understood more readily by reference to the following detailed description, examples, drawings, and claims, and their previous and following description. However, before the present compositions, articles, devices, systems, and/or methods are disclosed and described, it is to be understood that this invention is not limited to the specific embodiments of compositions, articles, devices, systems, and/or methods disclosed unless otherwise specified, as such can, of course, vary. It is also to be understood that the terminology used herein is for the purpose of describing particular aspects of the invention only and is not intended to be limiting.

The following description of the invention is also provided as an enabling teaching of the invention in its best, currently known embodiment. To this end, those of ordinary skill in the relevant art will recognize and appreciate that changes and modifications can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are thus also a part of the present invention. Thus, the following description is provided as illustrative of the principles of the present invention and not in limitation thereof.

Various combinations of elements of this disclosure are encompassed by this invention, e.g. combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Any publications mentioned herein are incorporated herein by reference to disclose and describe the methods and/or materials in connection with which the publications are cited.

It is also to be understood that the terminology used herein is for the purpose of describing particular aspects only and is not intended to be limiting. As used in the specification and in the claims, the term “comprising” may include the embodiments “consisting of” and “consisting essentially of” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a glass fiber” includes mixtures of two or more such glass fibers.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit falling within a range between two particular units are also disclosed. For example, if 10 and 15 are disclosed, then 11, 12, 13, and 14 are also disclosed.

As used herein, the terms “optional” or “optionally” mean that the subsequently described event, condition, component, or circumstance may or may not occur, and that the description includes instances where said event or circumstance occurs and instances where it does not.

As used herein, the term or phrase “effective,” “effective amount,” or “conditions effective to” refers to such amount or condition that is capable of performing the function or property for which an effective amount is expressed. As will be pointed out below, the exact amount or particular condition required may vary from one embodiment to another, depending on recognized variables such as the materials employed and the processing conditions observed. Thus, it is not always possible to specify an exact “effective amount” or “condition effective to” for each embodiment or aspect encompassed by the present disclosure. However, it should be understood that an appropriate effective amount or condition effective to achieve a desired results will be readily determined by one of ordinary skill in the art using only routine experimentation.

As used herein, the term or phrase “mechanical property improving additive” or the like terms refer to a substance or mixture of substances added to a composition that improves one or more properties of the material compared to the same material without the substance. Examples of the properties include, but are not limited to, tensile strength, tensile strain, tensile modulus, flexural strength, flexural modulus, notched Izod impact, unnotched Izod impact, or any combination thereof. A nonlimiting example of a mechanical property improving additive is Struktol® TR 063A.

As used herein, the term or phrase “impact strength increasing additive” or the like terms refer to a substance or mixture of substances added to a composition that improves the notched Izod impact (NII) property of a material. Thus, an impact strength increasing additive is also a mechanical property improving additive. Nonlimiting examples of impact strength increasing additives are Struktol® TR 063A, Struktol® TR065 or a mixture thereof.

As used herein, the term or phrase “conventional fiber reinforced polyamide formulation” or the like term refers a composition without a mechanical property improving additive and/or impact strength increasing additive. For example, a conventional fiber reinforced polyamide formulation can have the same components as a composition that is not considered a conventional fiber reinforced polyamide formulation but for the lack of a mechanical property improving additive and/or impact strength increasing additive.

Disclosed are the components to be used to prepare disclosed compositions of the invention as well as the compositions themselves to be used within methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific aspect or combination of aspects of the methods of the invention.

References in the specification and concluding claims to parts by weight, of a particular element or component in a composition or article, denote the weight relationship between the element or component and any other elements or components in the composition or article for which a part by weight is expressed. Thus, in a composition containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included. For example if a particular element or component in a composition or article is said to have 60% weight, it is understood that this percentage is relation to a total compositional percentage of 100%.

Each of the component starting materials disclosed herein are either commercially available and/or the methods for the production thereof are known to those of skill in the art.

As briefly summarized above, aspects of the present disclosure provide fiber reinforced thermoplastic polymer compositions that exhibit one or more improved performance properties relative to conventional reinforced thermoplastic compositions. For example, the disclosed fiber reinforced thermoplastic polymer compositions can comprise a mechanical property improving additive and/or an impact strength increasing additive. In one aspect, the mechanical property improving additive and/or an impact strength increasing additive, surprisingly and unexpectedly, can be more effective in compositions with a particular loading of a fiber reinforcement component.

The disclosed fiber reinforced compositions of the present invention generally comprise a thermoplastic polymer component and an additive. The additive can be an impact strength increasing additive. In another aspect, the additive can be a mechanical property improving additive. Surprisingly and unexpectedly, the incorporation of a mechanical property improving additive and/or an impact strength increasing additive in the disclosed reinforced thermoplastic compositions results in a reinforced composition that exhibits one or more improved performance properties relative to conventional reinforced thermoplastic compositions in the absence of the mechanical property improving additive and/or an impact strength increasing additive.

As noted above, the disclosed compositions comprise a thermoplastic polymer component. The thermoplastic polymer component comprises a polyamide polymer component. In one aspect, the polyamide polymer component can comprise a single polyamide or, alternatively, in another aspect can comprise a blend of two or more different polyamides. In one aspect, the polyamide polymer component can be nylon 6. In another aspect, the polyamide polymer component can be nylon 6,6. In another aspect, the polyamide polymer component can be a mixture of nylon 6 and nylon 6,6. The polyamide polymer component can be present in the composition in any desired amount. However, in some embodiments it is preferred that the polyamide polymer component be present in the composition in an amount in the range of from about 10 weight percent to 90 weight percent of the composition, preferably from about 30 to 65 weight percent of the composition. In another aspect, the polyamide polymer component present in the composition can be present in an amount of at least 15, 20, 25, 30, 35, 40, 45, 50, 55, 60, 65, 70, 75, 80, or 85 weight percent. In still further embodiments, the polyamide polymer component can be present in an amount within any range derived from any two of the above values, including for example, an amount in the range of from 10 weight percent to 70 weight percent, or an amount in the range of from 30 weight percent to 65 weight percent. For example, the polyamide polymer component can be a mixture of nylon 6 and nylon 6,6 and be present from 30 weight percent to 40 weight percent of the polyamide component.

According to aspects where the polyamide component comprises at least two different polyamides, it should be understood that the at least two different polyamides can be present in a desired relative weight ratio. For example, a first polyamide can be present in a relative weight ratio to a second polyamide in the range of from about 3:1 to about 9:1, including for example, additional exemplary weight ratios of about 4:1, about 5:1, about 6:1, about 7:1, or about 8:1. For example, in still a further aspect as described above where the polyamide component can comprise a nylon 6,6 polyamide and a nylon 6 polyamide, the relative weight ratio of the nylon 6,6 to the nylon 6 can be in the range of from about 3:1 to about 9:1.

The disclosed compositions further comprise a fiber reinforcement component, such as glass fibers, carbon fibers, aramid fibers, mineral fillers, etc., among others. Preferably, the fiber reinforcement component comprises a plurality of a fiber, such as glass fibers. To that end, the glass fibers can be relatively short glass fibers, relatively long glass fibers, such as long glass fibers, or a combination of both short and long glass fibers. In one aspect, the glass fibers can be long glass fibers. As used herein, the term short glass fibers refers to a population of glass fibers having an average fiber length less than or equal to about 5 mm. As used herein, the term long glass fibers refers to a population of glass fibers having an average fiber length greater than about 5 mm, including for example, a population of glass fibers having a fiber length in the range of from greater than 5 mm to 15 mm. Still further, the glass fibers can also be characterized by the filament diameter. To that end, suitable glass fibers can have any desired diameter. According to some aspects, it can be desirable however to minimize or reduce the glass fiber diameter as lower diameter glass fiber can result in improved impact properties. In still further aspects, the glass fiber can be characterized by an aspect ratio and cross-section. For example, glass fibers can have a relatively circular cross section. Alternatively, glass fibers can have a relatively flat or rectangular cross section.

The fiber reinforcement component can be present in the composition in any desired amount. However, in preferred aspects, the reinforcement component is preferably present in the composition in an amount from greater than 0 weight percent to about 70 weight percent, including exemplary amounts of 5 weight percent, 10 weight percent, 15 weight percent, 20 weight percent, 25 weight percent, 30 weight percent, 35 weight percent, 40 weight percent, 45 weight percent, 50 weight percent, 55 weight percent, 60 weight percent, and 65 weight percent. In still further embodiments, the fiber reinforcement component can be present in the composition in an amount in any range derived from any two of the above disclosed weight percent values, including for example from 20 to 50 weight percent or from 30 to 50 weight percent. Preferably, the fiber reinforcement component can be present in the composition in an amount in the range of about 55 to 65 weight percent. For example, the fiber reinforcement component can be present in the composition in an amount of about 60 weight percent

The disclosed fiber reinforced compositions can further optionally comprise a lubricant component. In one aspect, the lubricant component can contain a wax. Waxes are commonly used in the compounding and molding industry to serve functions of a lubricant, processing aid, slip agent and dispersant aid in polyamide compositions. An example of a commonly used wax based lubricant processing aid in polyamide compositions can be the ethylene bis-stearamide wax, Acrawax™ C, commercially available from Lonza. However, although such additives can help with improved processability of the polyamide compositions, they can also result in a negative effect on certain product physical properties.

The lubricant component can be present in the composition in any desired amount. However, in preferred aspects, the lubricant component is preferably present in the composition in an amount from greater than 0 weight percent to about 5 weight percent, including exemplary amounts of 1 weight percent, 2 weight percent, 3 weight percent, 4 weight percent, and 5 weight percent. In another example, the lubricant component is preferably present in the composition in an amount from greater than 0 weight percent to about 1 weight percent, including 0.10 weight percent, 0.20 weight percent, 0.30 weight percent, 0.40 weight percent, 0.50 weight percent, 0.60 weight percent, 0.70 weight percent, 0.80 weight percent, and 0.90 weight percent.

The disclosed fiber reinforced thermoplastic composition further comprises at least one mechanical property improving additive. According to further aspects, the mechanical property improving additive can be an impact strength increasing additive. For example, the thermoplastic composition can comprise a mechanical property improving additive. In another example, the thermoplastic composition can comprise an impact strength increasing additive. In yet another example, the thermoplastic composition can comprise a mechanical property improving additive and an impact strength increasing additive. In one aspect, an impact strength increasing additive can be a mechanical property improving additive. In one aspect, the mechanical property improving additive is not the same as the optional lubricant component. For example, the mechanical property improving additive can comprise Struktol® TR 063A, commercially available from the Struktol Company of America. To that end, surprisingly the use of Struktol® TR 063A at the weight percent levels disclosed herein resulted in a significant improvement in one or more mechanical properties.

The mechanical property improving additive can be present in the composition in any desired amount. However, in preferred aspects, the mechanical property improving additive is preferably present in the composition in an amount from greater than 0 weight percent to about 3 weight percent, including exemplary amounts of 1 weight percent, 2 weight percent, and 3 weight percent. In another example, the mechanical property improving additive is preferably present in the composition in an amount from greater than 0 weight percent to about 2 weight percent, including 0.25 weight percent, 0.50 weight percent, 0.75 weight percent, 1.0 weight percent, 1.25 weight percent, 1.50 weight percent, 1.75 weight percent, and 2.0 weight percent.

In one aspect, the composition comprising a mechanical property improving additive exhibits at least one mechanical property that is improved relative to that of a substantially identical reference composition in the absence of the mechanical property improving additive. In one aspect, the composition exhibits at least two mechanical properties that are improved relative to that of a substantially identical reference composition in the absence of the mechanical property improving additive. In one aspect, the composition exhibits at least three mechanical properties that are improved relative to that of a substantially identical reference composition in the absence of the mechanical property improving additive. In one aspect, the composition exhibits at least four mechanical properties that are improved relative to that of a substantially identical reference composition in the absence of the mechanical property improving additive. In one aspect, the composition exhibits at least five mechanical properties that are improved relative to that of a substantially identical reference composition in the absence of the mechanical property improving additive. An improved property can be a property that is at least 5 percent, 10 percent, 15 percent, 20 percent or 25 percent improved. Preferably, the mechanical property is at least 10 percent improved. The at least one improved mechanical property can include tensile strength, tensile strain, tensile modulus, flexural strength, flexural modulus, notched Izod impact, unnotched Izod impact, or any combination thereof.

In one aspect, the impact strength increasing additive is not the same as the lubricant component. In one aspect, the impact strength increasing additive comprises a processing aid. In another aspect, the impact strength increasing additive comprises a lubricant. In yet another aspect, the impact strength increasing additive comprises a blending agent. In yet another aspect, the impact strength increasing additive comprises a plurality of different molecular weight thermoplastic resins. In yet another aspect, the impact strength increasing additive comprises Struktol® TR 063A. In yet another aspect, the impact strength increasing additive comprises Struktol® TR065, also commercially available from Struktol Company of America. In yet another aspect, the impact strength increasing additive comprises a blend of Struktol® TR 063A and Struktol® TR065. The impact strength increasing additive can be present in the composition in any desired amount. However, in preferred aspects, the impact strength increasing additive is preferably present in the composition in an amount from greater than 0 weight percent to about 3 weight percent, including exemplary amounts of 1 weight percent, 2 weight percent, and 3 weight percent. In another example, the impact strength increasing additive is preferably present in the composition in an amount from greater than 0 weight percent to about 2 weight percent, including 0.25 weight percent, 0.50 weight percent, 0.75 weight percent, 1.0 weight percent, 1.25 weight percent, 1.50 weight percent, 1.75 weight percent, and 2.0 weight percent. In one aspect, the composition exhibits a notched Izod impact strength greater than that of a substantially identical reference composition in the absence of the impact strength increasing additive. In one aspect, the increase in notched Izod impact strength can be any increase in notched Izod impact strength. For example, according to aspects of the invention, disclosed compositions can exhibit at least about a 5% greater notched Izod impact strength than that of a corresponding reference composition. Further aspects can exhibit even greater increases in notched Izod impact strength, including for example increases of at least about 10% greater, at least about 15% greater, at least about 20%, at least about 25% greater, at least about 30% greater, at least about 40% greater, at least about 50% greater, at least about 60% greater, and even at least about 70% greater. Preferably, the compositions can exhibit at least about a 10% greater notched Izod impact strength than that of a corresponding reference composition. Thus, in one aspect, the notched Izod impact strength of the fiber reinforced thermoplastic composition is at least 10% greater than that of the substantially identical reference composition. In another aspect, the notched Izod impact strength of the fiber reinforced thermoplastic composition is at least 60% greater than that of the substantially identical reference composition. In another aspect, the notched Izod impact strength of the fiber reinforced thermoplastic composition is from 10% to 60% greater than that of the substantially identical reference composition. In another aspect, the notched Izod impact strength of the fiber reinforced thermoplastic composition is from 5% to 80% greater than that of the substantially identical reference composition.

The filled polyamide formulations may further contain additional minor components such as carbon black concentrate, processing aids, heat stabilizers, coupling agents and colorants. In one aspect, the thermoplastic composition optionally can comprise carbon black concentrate. The carbon black concentrate can be present in the composition in any desired amount. However, in preferred aspects, the carbon black concentrate is preferably present in the composition in an amount from greater than 0 weight percent to about 3 weight percent, including exemplary amounts of 1 weight percent, 2 weight percent, and 3 weight percent. In another example, the lubricant component is preferably present in the composition in an amount from greater than 0 weight percent to about 2 weight percent, including 0.25 weight percent, 0.50 weight percent, 0.75 weight percent, 1.00 weight percent, 1.25 weight percent, 1.50 weight percent, 1.75 weight percent, and 2.00 weight percent.

Accordingly, a non-limiting example of a disclosed thermoplastic composition can comprise a) from 30 to 40 weight percent of the polyamide component, wherein the polyamide component comprises nylon 6 and nylon 6,6; b) from 55 to 65 weight percent of the fiber reinforcement component, wherein the fiber reinforcement component comprises long glass fibers; c) from greater than 0 to 1 weight percent of the lubricant component, wherein the lubricant component comprises a wax; and d) from greater than 0.5 to 3 weight percent of the impact strength increasing additive, wherein the impact increasing strength additive comprises at least one of Struktol® TR 063A, and Struktol® TR065. Such composition can exhibit a notched Izod impact strength at least 10% greater than that of a substantially identical reference composition in the absence of the impact strength increasing additive. Such composition could also exhibit a notched Izod impact strength at least 30% greater than that of a substantially identical reference composition in the absence of the impact strength increasing additive. Even further, such composition could also exhibit a notched Izod impact strength at least 60% greater than that of a substantially identical reference composition in the absence of the impact strength increasing additive.

Another non-limiting example of a disclosed thermoplastic composition can comprise a) from 35 to 65 weight percent of the polyamide component, wherein the polyamide component comprises nylon 6 and nylon 6,6; b) from 35 to 65 weight percent of the fiber reinforcement component, wherein the fiber reinforcement component comprises long glass fibers; c) from greater than 0 to 1 weight percent of the optional lubricant component, wherein the lubricant component comprises a wax; and d) from greater than 0.5 to 3 weight percent of the mechanical property improving additive, wherein the mechanical property improving additive comprises Struktol® TR 063A.

In another aspect, also disclosed herein are methods for increasing the impact strength exhibited by a conventional fiber reinforced polyamide formulation comprising a weight percentage of a fiber reinforcement component; a weight percentage of a polyamide component; and a weight percentage of processing aid component. The methods according to this aspect generally comprise: a) providing the conventional fiber reinforced polyamide formulation; b) determining a weight percentage of an impact strength increasing additive, other than the processing aid component, to be incorporated into the conventional fiber reinforced polyamide formulation; c) substituting the determined weight percentage of the impact strength increasing additive for a corresponding weight percentage of the polyamide component to provide a fiber reinforced polyamide formulation exhibiting an increased impact strength; and d) preparing a fiber reinforced polyamide composition according to the provided fiber reinforced polyamide formulation of step c).

When the polyamide component comprises at least two polyamides, as described elsewhere herein, the at least two polyamides are present in the conventional fiber reinforced polyamide composition in a relative weight ratio. Pursuant to the method of this aspect, after substituting the determined weight percentage of the impact strength increasing additive for a corresponding weight percentage of the polyamide component in step c) the at least two polyamides remain present in the provided fiber reinforced polyamide formulation in the same relative weight ratio. In one aspect, the method produces a fiber reinforced polyamide formulation exhibiting an increased impact strength, comprises a) from 30 to 40 weight percent of the polyamide component, wherein the polyamide component comprises nylon 6 and nylon 6,6; b) from 55 to 65 weight percent of the fiber reinforcement component, wherein the fiber reinforcement component comprises long glass fibers; c) from greater than 0 to 1 weight percent of the lubricant component, wherein the processing aid component comprises a wax; and d) from greater than 0.5 to 3 weight percent of the impact strength increasing additive, wherein the impact increasing strength additive comprises at least one of Struktol® TR 063A and Struktol® TR065.

In still another aspect, also disclosed is a method for improving one or more mechanical property exhibited by a conventional fiber reinforced polyamide formulation comprising a weight percentage of a fiber reinforcement component; a weight percentage of a polyamide component; and a weight percentage of a processing aid component. According to this aspect, the method generally comprises a) providing the conventional fiber reinforced polyamide formulation; b) determining a weight percentage of a mechanical property improving additive, other than the processing aid component, to be incorporated into the conventional fiber reinforced polyamide formulation; c) substituting the determined weight percentage of the mechanical property improving additive for a corresponding weight percentage of the polyamide component to provide a fiber reinforced polyamide formulation exhibiting at least one improved mechanical property; and d) preparing a fiber reinforced polyamide composition according to the provided fiber reinforced polyamide formulation of step c). In one aspect, the fiber reinforced polyamide formulation exhibiting an improved mechanical property, comprises a) from 30 to 65 weight percent of the polyamide component; b) from greater than 35 to 70 weight percent of the fiber reinforcement component; and c) from greater than 0 to 1 weight percent of the optional lubricant; and d) from greater than 0 to 3 weight percent of the mechanical property improving additive. Once again, when the polyamide component comprises at least two polyamides, then the at least two polyamides are present in the conventional fiber reinforced polyamide composition in a relative weight ratio. After substituting the determined weight percentage of the mechanical property improving additive for a corresponding weight percentage of the polyamide component in step c) the at least two polyamides are present in the provided fiber reinforced polyamide formulation in the same relative weight ratio. In one aspect, the composition prepared in step d), of the method described above, comprises a) from 35 to 65 weight percent of the polyamide component, wherein the polyamide component comprises nylon 6 and nylon 6,6; b) from 35 to 65 weight percent of the fiber reinforcement component, wherein the fiber reinforcement component comprises long glass fibers; c) from greater than 0 to 1 weight percent of the optional lubricant component, wherein the lubricant component comprises a wax; and d) from greater than 0.5 to 3 weight percent of the mechanical property improving additive, wherein the mechanical property improving additive comprises Struktol® TR 063A.

In still further aspects, methods are provided for the manufacture of the fiber reinforced compositions disclosed herein. A method according to this aspect generally comprises forming a composite mixture of the polyamide resin component and the fiber reinforcement component. The step of forming the composite can comprise contacting a provided reinforcing fiber component as described above with the polyamide component to provide a fiber reinforced thermoplastic composite. As one of ordinary skill in the art will appreciate, this contacting step can vary depending upon the nature of the glass fiber reinforcement component. For example, according to some aspects the contacting step can be performed by a continuous one step pultrusion process. As one of ordinary skill in the art will appreciate, a pultrusion process can be better suited for use in those aspects where the reinforcing fiber material comprises long glass fiber. According to these aspects, glass fiber rovings can be continuously pulled off a spool and through a resin mixture coating or impregnation station where they are coated or impregnated with a melt comprising the resin mixture. The coated or impregnated glass fiber strands can then be cooled and subsequently pelletized. These pellets can then be injection molded into test specimen parts in their existing form for property testing or into molded parts of varying complexity for use in desired end use applications. If one or more optional additives are desired to be incorporated into the fiber reinforced thermoplastic compositions, they can be introduced either during the pultrusion process or by dry-blending with pelletized reinforced thermoplastic composition following the pultrusion process and before any subsequent molding steps. In one aspect, the components (excluding glass fibers) including Struktol and any optional lubricant can first be blended (i.e. dry blend) before feeding in to the extruder. For compositions comprising short glass fibers, these fibers can be fed separately using a different feeder. For compositions comprising long glass fibers, the continuous fibers can be unwound from a spool and pulled in to the polymer melt, the polymer melt can come from the extruder to which dry blended raws were fed for impregnation—as described by the pultrusion process described herein.

While typical aspects have been set forth for the purpose of illustration, the foregoing descriptions should not be deemed to be a limitation on the scope of the invention. Accordingly, various modifications, adaptations, and alternatives can occur to one skilled in the art without departing from the spirit and scope of the present invention.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

In the following examples, improved properties of various long and short glass fiber reinforced polyamide resins were evaluated using Struktol® TR 063A and/or Struktol® TR065 minor additive components. Long glass fiber polyamide pellets were produced by a pultrusion process using Berstorff 44 mm twin-screw extruder operated at barrel temperatures of about 305-330° C. (580-630° F.) and screw speed of 300 rpm. Controlling long glass content is well known to one of ordinary skill in the art and can be done precisely by using outlet dies with known hole/opening diameters through which the polymer-impregnated glass is pultruded. Samples were molded into ISO/ASTM test specimens for property testing. All samples were generated at line speeds of 20-25 ft/min. The short glass filled polyamide samples were made compounded on a 25 mm twin-screw extruder operated at barrel temperatures of about 500-550° F., screw speed of about 175 rpm, and a throughput of about 18 lbs/hr. Samples were molded into ISO/ASTM test specimens for property testing.

### 1. Example 1

In the present case, Struktol TR 063A, which is known to offer similar processing benefits as the standard waxes (such as Acrawax™ C), was evaluated in filled polyamide compositions. Samples in the presence of the Struktol TR 063A were made with and without the presence of the ethylene bis-stearamide wax.

a. Description and Operation:

Samples were compounded on a twin-screw extruder with temperatures in the range or 500-550° F. Sample test specimens were molded on an injection-molding machine with temperatures in the range of 500-550° F. All testing was done according to ISO/ASTM procedures as discussed in the upcoming section.

b. Results

One set of formulations that was evaluated along with the generated product properties is presented in Table 1. The benefit due to addition of the Struktol TR 063A is observed as seen in Table 1.

TABLE I

| | Sample 1 | Sample 2 | Sample 3 | Sample 4 |
|---|---|---|---|---|
| Raw Material | | | | |
| Short Glass fibers | 35 | 35 | 60 | 60 |
| PA66 | 57.01 | 56.12 | 34.52 | 33.62 |
| PA6 | 6.34 | 6.23 | 3.83 | 3.73 |
| Carbon black | 1.15 | 1.15 | 1.15 | 1.15 |
| concentrate | | | | |
| Lubricant | 0.1 | 0.1 | 0.1 | 0.1 |
| (Acrawax C) | | | | |
| Heat stabilizer | 0.4 | 0.4 | 0.4 | 0.4 |
| Struktol TR0063 | — | 1.0 | — | 1.0 |
| Property | | | | |
| Specific Gravity | 1.441 | 1.444 | 1.746 | 1.751 |
| (ASTM D792) | | | | |
| Tensile Modulus, | 8480.8 | 9557.8 | 15287.6 | 15549.6 |
| MPa (ISO 527) | | | | |
| Tensile Strength, | 142.02 | 177.55 | 188 | 207.55 |
| MPa (ISO 527) | | | | |
| Tensile Strain, % | 2.74 | 2.85 | 1.98 | 2.22 |
| (ISO 527) | | | | |
| Flexural Modulus, | 8700.6 | 9858 | 18523.6 | 18715.2 |
| MPa (ISO 178) | | | | |
| Flexural Strength, | 216.96 | 245.86 | 307.92 | 310.32 |
| MPa (ISO 178) | | | | |
| N Izod Impact, | 7.25 | 9.58 | 13.81 | 13.93 |
| kJ/m² (ISO 180) | | | | |
| UN Izod Impact, | 56.76 | 60.23 | 47.85 | 51.49 |
| kJ/m² (ISO 180) | | | | |

Another variation of the above formulations is shown in Table 2. The benefit of using the Struktol TR 063A in place of the conventional lubricant, Acrawax™ C, is observed in Table 2.

TABLE 2

| | Sample 1 | Sample 2 | Sample 3 |
|---|---|---|---|
| Raw Material | | | |
| Short Glass fibers | 60 | 60 | 60 |
| PA66 | 30.2 | 30.85 | 29.85 |
| PA6 | 8.00 | 8.00 | 8.00 |
| Carbon black | 1.15 | 1.15 | 1.15 |
| concentrate | | | |
| Lubricant | 0.20 | — | — |
| (Acrawax C) | | | |
| Heat stabilizer | 0.45 | — | — |
| Struktol TR 063A | — | — | 1.0 |
| Property | | | |
| Tensile Strength, | 226 | 237 | 248 |
| MPa (ISO 527) | | | |
| Tensile Strain, % | 2.2 | 2.4 | 2.4 |
| (ISO 527) | | | |
| Flexural Strength, | 347 | 364 | 376 |
| MPa (ISO 178) | | | |
| Flexural Modulus, | 18.6 | 19 | 18.9 |
| MPa (ISO 178) | | | |
| N Izod Impact, | 15.9 | 16.8 | 16.8 |
| kJ/m² (ISO 180) | | | |

### 2. Example 2

a. Description and Operation

The process to produce long fiber reinforced thermoplastic polymer pellets is a one-step continuous process in which the fiber rovings are pulled off the spool through a polymer coating/impregnation set-up where they are coated with the polymer melt. The polymer-coated strands are then cooled and pelletized. These pellets can then be injection molded into test specimens in their existing form or after dry-blending them with additional components for property testing or into parts of varying complexity for use in real world applications.

Struktol TR 063A and Struktol TR065 were evaluated as minor components with loading levels of up to 1.0 wt % in Verton polyamide formulations containing long glass fibers in the range of 35-60 wt %. All samples were pultruded using a Berstorff 44 mm twin-screw extruder located at LNP's Verton R&D site in Columbus, Ind. Formulations were compounded at ˜305-330° C. (580-630° F.) barrel set temperatures and screw speed of 300 rpm. Controlling glass content in any given Verton product is well understood and can be done precisely by using outlet dies with known hole/opening diameters through which the polymer-impregnated glass is pultruded. Pultruded samples were molded into ISO/ASTM test specimens for property testing. All samples were generated at line speeds of 20-25 ft/min. Control product formulations in absence of the Struktol additives are given in Table 3. For samples using the Struktol additive(s), polyamide 66 (PA66) and polyamide 6 (PA6) contents from the existing (control) formulations were reduced to accommodate for the amount(s) of Struktol additive(s) being used. A constant ratio of PA66/PA6 was maintained in all the samples pultruded in this experimentation.

TABLE 3

| | 35 wt % long | ~50 wt % long | 60 wt % long |
|---|---|---|---|
| Raw Material | glass fibers | glass fibers | glass fibers |
| Long Glass fibers | 35 | 50 | 60 |
| PA66 | 57.01 | 43.52 | 34.51 |
| PA6 | 6.34 | 4.84 | 3.84 |
| Carbon black | 1.15 | 1.15 | 1.15 |
| concentrate | | | |
| Lubricant | 0.10 | 0.10 | 0.10 |
| Heat Stabilizer | 0.40 | 0.40 | 0.40 |

b. Results

Table 4 shows the results from the Design of Experiment (DOE). The NII for a 60% glass filled Verton PA product (control) without the Struktol additives as seen from data for Run #8 in Table 4 is ˜56 kJ/m². In presence of the Struktol additive(s), the same property is seen to be as high as ˜90 kJ/m², an improvement of ˜60%, as seen from data for runs 18 and 21 in the same Table. In comparison, the two other glass fiber content levels of 35 and 47.5 wt % do not show such a big jump in the NII property.

Based on the experimental data analysis, it is seen that Struktol TR 063A significantly boosts the NII performance, particularly of the 60 wt % long fiber reinforced polyamide product. Table 4 below shows Struktol TR 063A and Struktol TR065 Evaluation in Verton Polyamide Products. All samples were done on Block 1. F1=Factor 1 (A:TR065), F2=Factor 2 (B:TR 063A), F3=Factor 3 (C:Glass), F4=Factor 4 (D:Acrawax), R1=Response 1 (Tensile Strength MPa), R2=Response 2 (Tensile strain %), R3=Response 3 (Tensile Mod MPa), R4=Response 4 (Flexurla Strength MPa), R5=Response 5 (NII KJ/m²), R6=Response 6 (UNII KJ/m²), R7=Response 7 (MAI (TE) J).

TABLE 4

| Run | F1 | F2 | F3 | F4 | R1 | R2 | R3 | R4 | R5 | R6 | R7 |
|---|---|---|---|---|---|---|---|---|---|---|---|
| 1 | 1.00 | 0.00 | 35.00 | No | 204 | 1.82 | 12588.8 | 289.87 | 34.42 | 55.28 | 15 |
| 2 | 1.00 | 0.00 | 35.00 | Yes | 194.37 | 1.72 | 12112.4 | 206.71 | 29.62 | 49.59 | 16.8 |
| 3 | 1.00 | 1.00 | 35.00 | No | 189.34 | 1.48 | 13416 | 299.05 | 29.47 | 51.61 | 17.3 |
| 7 | 0.00 | 0.00 | 35.00 | No | 193.7 | 1.64 | 12689.2 | 289.17 | 31.69 | 53.68 | 16.2 |
| 13 | 0.50 | 0.50 | 35.00 | No | 202.4 | 1.68 | 13077.2 | 293.89 | 35.29 | 53.43 | 17.8 |
| 15 | 1.00 | 1.00 | 35.00 | No | 180.48 | 1.4 | 13419 | 283.45 | 35.4 | 55.64 | 16.9 |
| 17 | 0.00 | 1.00 | 35.00 | Yes | 185.95 | 1.48 | 13213.4 | 276.2 | 31.38 | 45.01 | 14.7 |
| 19 | 0.00 | 1.00 | 35.00 | Yes | 173.85 | 1.38 | 13260.6 | 231.82 | 29.85 | 46.18 | 13.4 |
| 22 | 1.00 | 0.50 | 35.00 | Yes | 184.8 | 1.48 | 12961.2 | 273.3 | 32.98 | 53.09 | 14.8 |
| 23 | 0.00 | 0.00 | 35.00 | Yes | 201.91 | 1.82 | 12225.4 | 254.36 | 30.28 | 59.29 | 16 |
| 4 | 0.50 | 0.00 | 47.50 | No | 250.95 | 1.6 | 16674 | 345.59 | 41.7 | 66.73 | 18.5 |
| 9 | 0.50 | 0.25 | 47.50 | Yes | 247.84 | 1.62 | 16066.2 | 356.28 | 48.37 | 72.6 | 16.3 |
| 10 | 0.75 | 0.75 | 47.50 | No | 236.35 | 1.44 | 17045.4 | 356.92 | 48.67 | 72.46 | 15.5 |
| 12 | 0.50 | 1.00 | 47.50 | Yes | 232.52 | 1.48 | 16484.6 | 331.07 | 38.99 | 58.08 | 16.4 |
| 20 | 0.00 | 0.50 | 47.50 | No | 250.89 | 1.56 | 16814.8 | 357.46 | 44.89 | 75.45 | 16.7 |
| 5 | 1.00 | 0.00 | 60.00 | Yes | 253.97 | 1.2 | 22406.2 | 407.35 | 60.31 | 93.14 | 22.9 |
| 6 | 1.00 | 0.00 | 60.00 | Yes | 257.63 | 1.2 | 22761.4 | 422.38 | 61.61 | 104.31 | 21.8 |
| 8 | 0.00 | 0.00 | 60.00 | No | 271.7 | 1.4 | 22262.6 | 408.35 | 56.42 | 92.94 | 22.2 |
| 11 | 0.00 | 1.00 | 60.00 | No | 223.72 | 0.98 | 23395 | 411.67 | 80.45 | 103.26 | 2.4 |
| 14 | 0.00 | 0.50 | 60.00 | Yes | 254.21 | 1.18 | 23113.6 | 409.9 | 70.72 | 99.88 | 23.1 |
| 16 | 1.00 | 0.50 | 60.00 | No | 233.52 | 1 | 23629.6 | 409.28 | 83.88 | 92.58 | 19.8 |
| 18 | 1.00 | 1.00 | 60.00 | Yes | 252.89 | 1.18 | 22982.5 | 412.82 | 90.27 | 109.04 | 20.6 |
| 21 | 0.00 | 0.50 | 60.00 | Yes | 233.53 | 1.04 | 23437.8 | 416.49 | 91.36 | 105.5 | 19.5 |
| 24 | 0.00 | 1.00 | 60.00 | No | 236.03 | 1.04 | 23655.6 | 411.89 | 76.79 | 101.91 | 20.5 |

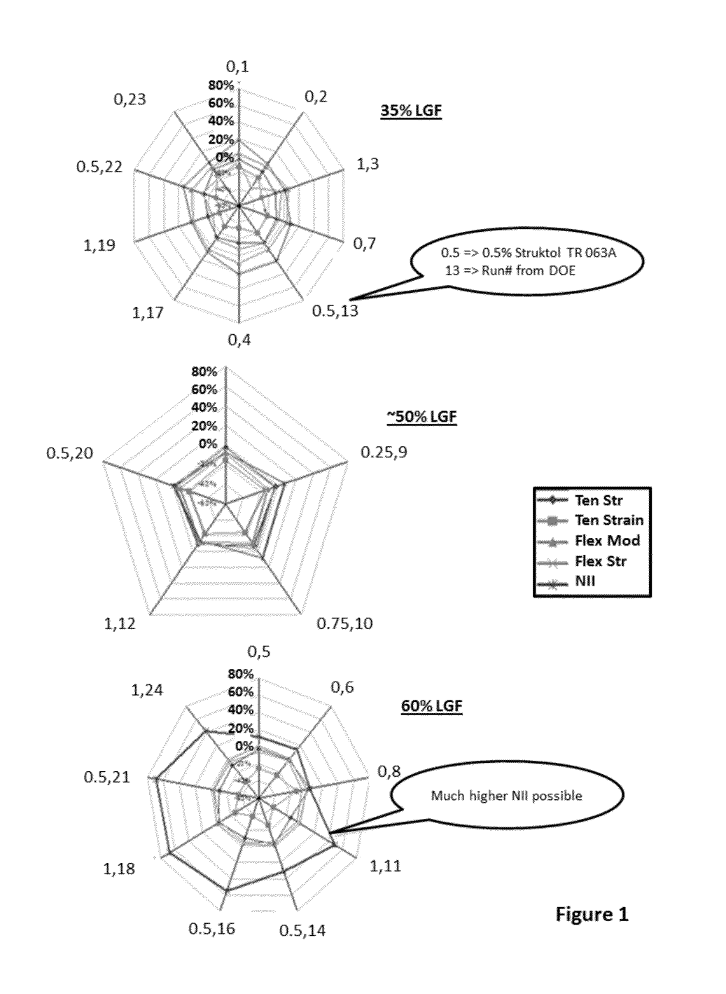

FIG. 1 shows the data in the form of spider charts of the respective long glass fiber (LGF) content levels. The benefit of Struktol TR 063A in improving NII for 60 wt % glass fiber content is observed in FIG. 1.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A fiber reinforced thermoplastic composition, comprising:
a) a polyamide polymer component;
b) a fiber reinforcement component;
c) a lubricant component; and
d) an impact strength increasing additive other than the lubricant component.

2. The fiber reinforced thermoplastic composition of claim 1, comprising
a) from 30 to 65 weight percent of the polyamide component;
b) from greater than 0 to 70 weight percent of the fiber reinforcement component;
c) from greater than 0 to 1 weight percent of the lubricant component; and
d) from greater than 0 to 3 weight percent of the impact strength increasing additive.

3. The fiber reinforced thermoplastic composition of claim 2, wherein the impact strength increasing additive comprises a processing aid.

4. The fiber reinforced thermoplastic composition of claim 3, wherein the impact strength increasing additive comprises a lubricant.

5. The fiber reinforced thermoplastic composition of claim 3, wherein the impact strength increasing additive comprises a blending agent.

6. The fiber reinforced thermoplastic composition of claim 5, wherein the impact strength increasing additive comprises a plurality of different molecular weight thermoplastic resins.

7. The fiber reinforced thermoplastic composition of claim 2, wherein the impact strength increasing additive comprises Struktol® TR 063A.

8. The fiber reinforced thermoplastic composition of claim 2, wherein the impact strength increasing additive comprises Struktol® TR065.

9. The fiber reinforced thermoplastic composition of claim 2, wherein the impact strength increasing additive comprises a blend of Struktol® TR 063A and Struktol® TR065.

10. The fiber reinforced thermoplastic composition of claim 2, wherein the polyamide component comprises at least two polyamides.

11. The fiber reinforced thermoplastic composition of claim 10 wherein the polyamide component comprises nylon 6 and nylon 6,6.

12. The fiber reinforced thermoplastic composition of claim 11 wherein the nylon 6,6 and nylon 6 are present in a relative weight ratio in the range of from about 3:1 to 9:1.

13. The fiber reinforced thermoplastic composition of claim 2, wherein the fiber reinforcement component comprises a glass fiber.

14. The fiber reinforced thermoplastic composition of claim 2, wherein the fiber reinforcement component comprises a long glass fiber.

15. The fiber reinforced thermoplastic composition of claim 2, wherein the composition exhibits a notched Izod impact strength greater than that of a substantially identical reference composition in the absence of the impact strength increasing additive.

16. The fiber reinforced thermoplastic composition of claim 15, wherein the notched Izod impact strength of the fiber reinforced thermoplastic composition is at least 10% greater than that of the substantially identical reference composition.

17. The fiber reinforced thermoplastic composition of claim 15, wherein the notched Izod impact strength of the fiber reinforced thermoplastic composition is at least 60% greater than that of the substantially identical reference composition.

18. The fiber reinforced thermoplastic composition of claim 15, wherein the notched Izod impact strength of the fiber reinforced thermoplastic composition is from 10% to 60% greater than that of the substantially identical reference composition.

19. The fiber reinforced thermoplastic composition of claim 2, comprising
a) from 30 to 40 weight percent of the polyamide component, wherein the polyamide component comprises nylon 6 and nylon 6,6;
b) from 55 to 65 weight percent of the fiber reinforcement component, wherein the fiber reinforcement component comprises long glass fibers;
c) from greater than 0 to 1 weight percent of the lubricant component, wherein the lubricant component comprises a wax; and
d) from greater than 0.5 to 3 weight percent of the impact strength increasing additive, wherein the impact increasing strength additive comprises at least one of Struktol® TR 063A, and Struktol® TR065.

20. The fiber reinforced thermoplastic composition of claim 19, wherein the composition exhibits a notched Izod impact strength at least 10% greater than that of a substantially identical reference composition in the absence of the impact strength increasing additive.

21. The fiber reinforced thermoplastic composition of claim 19, wherein the composition exhibits a notched Izod impact strength at least 30% greater than that of a substantially identical reference composition in the absence of the impact strength increasing additive.

22. The fiber reinforced thermoplastic composition of claim 19, wherein the composition exhibits a notched Izod impact strength at least 60% greater than that of a substantially identical reference composition in the absence of the impact strength increasing additive.

23. A method for increasing the impact strength exhibited by a conventional fiber reinforced polyamide formulation comprising a weight percentage of a fiber reinforcement component; a weight percentage of a polyamide component; and a weight percentage of processing aid component; the method comprising:
a) providing the conventional fiber reinforced polyamide formulation;
b) determining a weight percentage of an impact strength increasing additive, other than the processing aid component, to be incorporated into the conventional fiber reinforced polyamide formulation;
c) substituting the determined weight percentage of the impact strength increasing additive for a corresponding weight percentage of the polyamide component to provide a fiber reinforced polyamide formulation exhibiting an increased impact strength; and
d) preparing a fiber reinforced polyamide composition according to the provided fiber reinforced polyamide formulation of step c).

24. The method of claim 23, wherein the fiber reinforced polyamide formulation exhibiting an increased impact strength, comprises
a) from 30 to 65 weight percent of the polyamide component;
b) from greater than 0 to 70 weight percent of the fiber reinforcement component;
c) from greater than 0 to 1 weight percent of the processing aid; and
d) from greater than 0 to 3 weight percent of the impact strength increasing additive.

25. The method of claim 24, wherein the impact strength increasing additive comprises a processing aid.

26. The method of claim 24, wherein the impact strength increasing additive comprises a lubricant.

27. The method of claim 24, wherein the impact strength increasing additive comprises a blending agent.

28. The method of claim 27, wherein the impact strength increasing additive comprises a plurality of different molecular weight thermoplastic resins.

29. The method of claim 24, wherein the impact strength increasing additive comprises Struktol® TR 063A.

30. The method of claim 24, wherein the impact strength increasing additive comprises Struktol® TR065.

31. The method of claim 24, wherein the impact strength increasing additive comprises a blend of Struktol® TR 063A and Struktol® TR065.

32. The method of claim 24, wherein the polyamide component comprises at least two polyamides.

33. The method of claim 32, wherein the polyamide component comprises nylon 6 and nylon 6,6.

34. The method of claim 33, wherein the nylon 6,6 and nylon 6 are present in a relative weight ratio in the range of from about 3:1 to 9:1.

35. The method of claim 32, wherein the at least two polyamides are present in the conventional fiber reinforced polyamide composition in a relative weight ratio and wherein after substituting the determined weight percentage of the impact strength increasing additive for a corresponding weight percentage of the polyamide component in step c) the at least two polyamides are present in the provided fiber reinforced polyamide formulation in the same relative weight ratio.

36. The method of claim 24, wherein the fiber reinforcement component comprises a glass fiber.

37. The method of claim 24, wherein the fiber reinforcement component comprises a long glass fiber.

38. The method of claim 24, wherein the provided fiber reinforced polyamide composition of step d) exhibits a notched Izod impact strength at least 10% greater than the conventional fiber reinforced polyamide composition in the absence of the impact strength increasing additive.

39. The method of claim 24, wherein the provided fiber reinforced polyamide composition of step d) exhibits a notched Izod impact strength at least 30% greater than the conventional fiber reinforced polyamide composition in the absence of the impact strength increasing additive.

40. The method of claim 24, wherein the provided fiber reinforced polyamide composition of step d) exhibits a notched Izod impact strength at least 60% greater than the conventional fiber reinforced polyamide composition in the absence of the impact strength increasing additive.

41. The method of claim 24, wherein the provided fiber reinforced polyamide composition of step d) exhibits a notched Izod impact strength from 10% to 60% greater than the conventional fiber reinforced polyamide composition in the absence of the impact strength increasing additive.

42. The method of claim 24, wherein the fiber reinforced polyamide formulation exhibiting an increased impact strength, comprises
a) from 30 to 40 weight percent of the polyamide component, wherein the polyamide component comprises nylon 6 and nylon 6,6;
b) from 55 to 65 weight percent of the fiber reinforcement component, wherein the fiber reinforcement component comprises long glass fibers;
c) from greater than 0 to 1 weight percent of the lubricant component, wherein the processing aid component comprises a wax; and
d) from greater than 0.5 to 3 weight percent of the impact strength increasing additive, wherein the impact increasing strength additive comprises at least one of Struktol® TR 063A and Struktol® TR065.

43. A fiber reinforced thermoplastic composition, comprising:
a) a polyamide polymer component;
b) a fiber reinforcement component;
c) an optional lubricant component; and
d) a mechanical property improving additive other than the optional lubricant component.

44. The fiber reinforced thermoplastic composition of claim 45, comprising
a) from 30 to 65 weight percent of the polyamide component;
b) from 35 to 70 weight percent of the fiber reinforcement component;
c) from greater than 0 to 1 weight percent of the optional lubricant component; and
d) from greater than 0 to 3 weight percent of the mechanical property improving additive.

45. The fiber reinforced thermoplastic composition of claim 44, wherein the mechanical property improving additive comprises Struktol® TR 063A.

46. The fiber reinforced thermoplastic composition of claim 45, wherein the polyamide component comprises at least two polyamides.

47. The fiber reinforced thermoplastic composition of claim 46, wherein the polyamide component comprises nylon 6 and nylon 6,6.

48. The fiber reinforced thermoplastic composition of claim 46, wherein the nylon 6,6 and nylon 6 are present in a relative weight ratio in the range of from about 3:1 to 9:1.

49. The fiber reinforced thermoplastic composition of claim 45, wherein the fiber reinforcement component comprises a glass fiber.

50. The fiber reinforced thermoplastic composition of claim 45, wherein the fiber reinforcement component comprises a short glass fiber.

51. The fiber reinforced thermoplastic composition of claim 45, wherein the composition exhibits at least one mechanical property that is improved relative to that of a substantially identical reference composition in the absence of the mechanical property improving additive.

52. The fiber reinforced thermoplastic composition of claim 51, wherein the at least one improved mechanical property comprises tensile strength, tensile strain, tensile modulus, flexural strength, flexural modulus, notched Izod impact, unnotched Izod impact, or any combination thereof.

53. The fiber reinforced thermoplastic composition of claim 45, comprising
a) from 35 to 65 weight percent of the polyamide component, wherein the polyamide component comprises nylon 6 and nylon 6,6;
b) from 35 to 65 weight percent of the fiber reinforcement component, wherein the fiber reinforcement component comprises long glass fibers;
c) from greater than 0 to 1 weight percent of the optional lubricant component, wherein the lubricant component comprises a wax; and
d) from greater than 0.5 to 3 weight percent of the mechanical property improving additive, wherein the mechanical property improving additive comprises Struktol® TR 063A.

54. A method for improving one or more mechanical property exhibited by a conventional fiber reinforced polyamide formulation comprising a weight percentage of a fiber reinforcement component; a weight percentage of a polyamide component; and a weight percentage of a processing aid component; the method comprising:
a) providing the conventional fiber reinforced polyamide formulation;
b) determining a weight percentage of a mechanical property improving additive, other than the processing aid component, to be incorporated into the conventional fiber reinforced polyamide formulation;
c) substituting the determined weight percentage of the mechanical property improving additive for a corresponding weight percentage of the polyamide component to provide a fiber reinforced polyamide formulation exhibiting at least one improved mechanical property; and
d) preparing a fiber reinforced polyamide composition according to the provided fiber reinforced polyamide formulation of step c).

55. The method of claim 54, wherein the fiber reinforced polyamide formulation exhibiting an improved mechanical property, comprises
a) from 30 to 65 weight percent of the polyamide component;
b) from greater than 35 to 70 weight percent of the fiber reinforcement component;
c) from greater than 0 to 1 weight percent of the optional lubricant; and
d) from greater than 0 to 3 weight percent of the mechanical property improving additive.

56. The method of claim 55, wherein the mechanical property improving additive comprises Struktol® TR 063A.

57. The method of claim 56, wherein the polyamide component comprises at least two polyamides.

58. The method of claim 57, wherein the polyamide component comprises nylon 6 and nylon 6,6.

59. The method of claim 58, wherein the nylon 6,6 and nylon 6 are present in a relative weight ratio in the range of from about 3:1 to 9:1.

60. The method of claim 57, wherein the at least two polyamides are present in the conventional fiber reinforced polyamide composition in a relative weight ratio and wherein after substituting the determined weight percentage of the mechanical property improving additive for a corresponding weight percentage of the polyamide component in step c) the at least two polyamides are present in the provided fiber reinforced polyamide formulation in the same relative weight ratio.

61. The method of claim 55, wherein the fiber reinforcement component comprises a glass fiber.

62. The method of claim 55, wherein the fiber reinforcement component comprises a short glass fiber.

63. The method of claim 55, wherein the composition prepared in step d) exhibits at least one mechanical property that is improved relative to that of a substantially identical reference composition in the absence of the mechanical property improving additive.

64. The method of claim 63, wherein the at least one improved mechanical property comprises tensile strength, tensile strain, tensile modulus, flexural strength, flexural modulus, notched Izod impact, unnotched Izod impact, or any combination thereof.

65. The method of claim 55, wherein the composition prepared in step d) comprises
a) from 35 to 65 weight percent of the polyamide component, wherein the polyamide component comprises nylon 6 and nylon 6,6;
b) from 35 to 65 weight percent of the fiber reinforcement component, wherein the fiber reinforcement component comprises long glass fibers;
c) from greater than 0 to 1 weight percent of the optional lubricant component, wherein the lubricant component comprises a wax; and
d) from greater than 0.5 to 3 weight percent of the mechanical property improving additive, wherein the mechanical property improving additive comprises Struktol® TR 063A.
